(19) United States
(12) Patent Application Publication
(10) Pub. No.: US 2012/0098308 A1
(43) Pub. Date: Apr. 26, 2012

(54) Vehicle salon and cargo area cover and method of using the same

(76) Inventor: Adil Aliyevich Aliev, Jefferson, MD (US)

(21) Appl. No.: 12/909,051

(22) Filed: Oct. 21, 2010

(51) Int. Cl. B60N 2/60

(52) U.S. Cl. 297/219.1

(57) ABSTRACT

An apparatus for covering seat and/or salon/cargo area in vehicles with a flexible base sheet with plurality of slots and/or loops, formed by stitching at least one narrow strip of material such as webbing to the base sheet with plurality of cross stitches, and method of using the same.

### CROSS REFERENCE TO RELATED APPLICATIONS

This is a continuation of U.S. Pat. No. 7,287,813 B2, filed on Oct. 30, 2007.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of vehicle accessories and more specifically to a vehicle seat cover for covering both the rear seat of a vehicle and sides and the rear face of the front seat of the vehicle when cargo is stored in the rear seat and method of using the cover.

A wide variety of protective covers have been utilized to protect vehicle seats from damage when a load is carried in the salon of the vehicle. Animals are often transported in cars and SUVs and can cause considerable damage to the interior of the vehicle. Unrestricted animals also tend to jump in the front seat to be close to their owners and by doing that causing a considerable hazard when the vehicle is in motion.

The present invention is a development from previously patented invention # U.S. Pat. No. 7,287,813 B2 and presents considerable revision and improvement over the prior art.

The referred to prior art had some shortcomings that needed improvements, such as: it had too many parts, therefore it was too complicated and too expensive to make. The prior art was also too narrowly specialized and did not provide adequate barrier for the pet to go over to the front seat.

### BRIEF SUMMARY OF THE INVENTION

The primary object of the invention is easy to make.

Another object of the invention is easy to use.

Another object of the invention is Universal—fits any vehicle.

A further object of the invention is Protects the car salon front, back and the sides (doors).

Another object of the invention is safe for the driver.

A further object of the invention is safe for the pet. Yet another object of the invention is can be used as cargo area liner.

Yet another object of the invention is prevents pet from jumping on the driver's seat.

Still yet another object of the invention is protects cargo area of the vehicle.

Another object of the invention is safe for the driver.

A further object of the invention is safe for the pet.

Still yet another object of the invention is can be used outside of the vehicle as regular pet bedding or as picnic blanket.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an apparatus for covering seat and/or salon/cargo area in vehicles comprising a flexible base sheet with plurality of slots and/or loops, formed by attached narrow strip of material such as webbing.

In accordance with a preferred embodiment of the invention, there is disclosed a method of using the apparatus for covering seat and/or salon/cargo area in vehicles comprising of the steps of inserting headrest's pins into the slots formed by the said strip of material stitched to the sheet and then partially wrapping the sheet around the headrest and inserting the headrest into the corresponding headrest slots in the back of the car front and/or rear seats, and sides of the cover raised to protect doors of the vehicle.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a diagram of the preferred embodiment of the invention.

FIG. 2 is a perspective view of the invention installed in the vehicle with sides raised.

FIG. 3 is a perspective view from the rear of the vehicle of the invention installed in the vehicle with sides up showing an example of attachment of the sides to the rear headrest's pin.

FIG. 4 is demonstration of the method of using the invention, showing process step by step in diagram with a perspective view of each step:

FIG. 4-A shows how to insert the headrest pins in the slots; FIG. 4-B shows how the headrest (front seat headrest in this case) should be rotated; FIG. 4-C shows step where the Headrest makes the final turn before being inserted in the back of the front seat; FIG. 4-D shows the headrest inserted in the appropriate place in the front seat.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

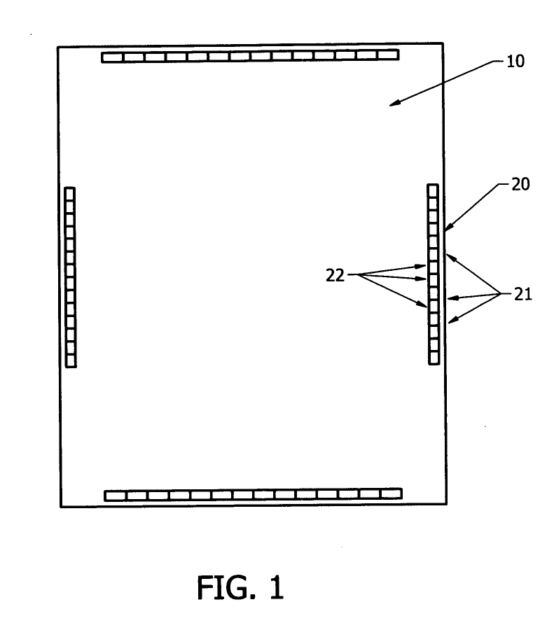

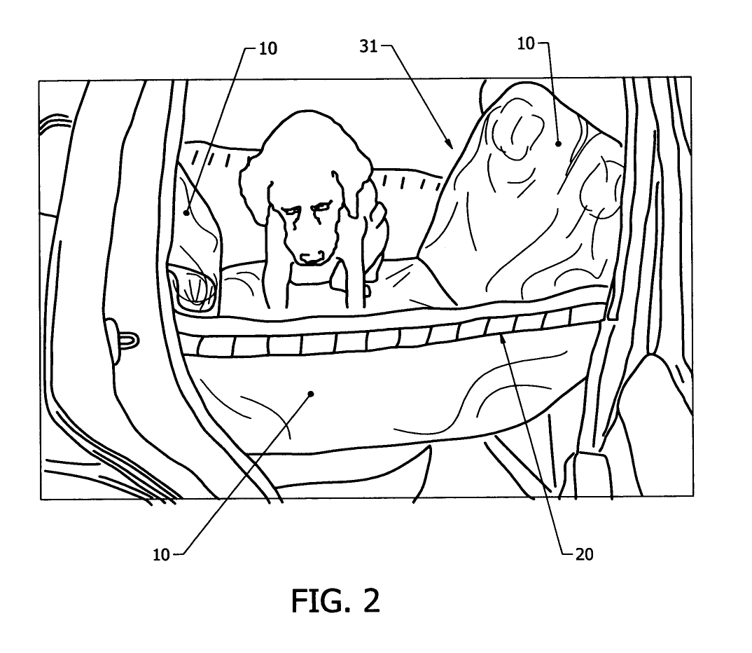

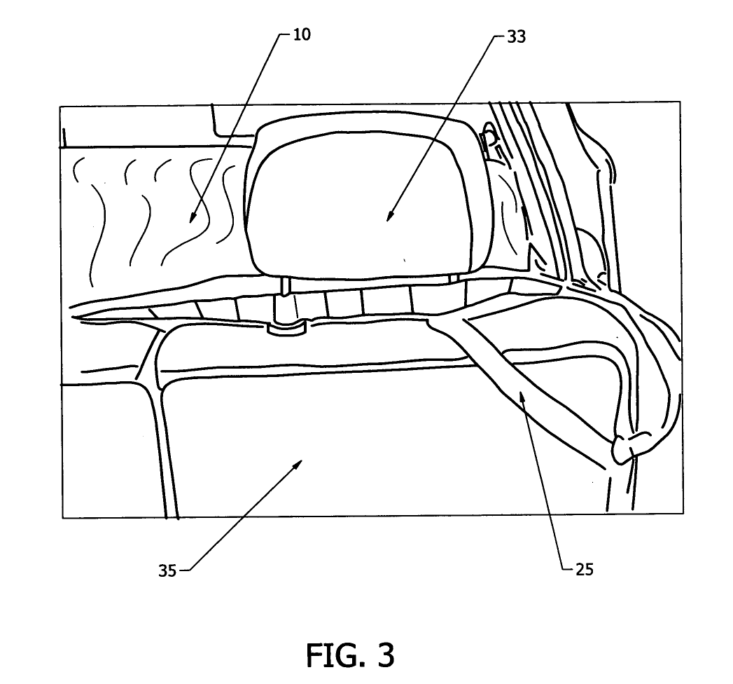

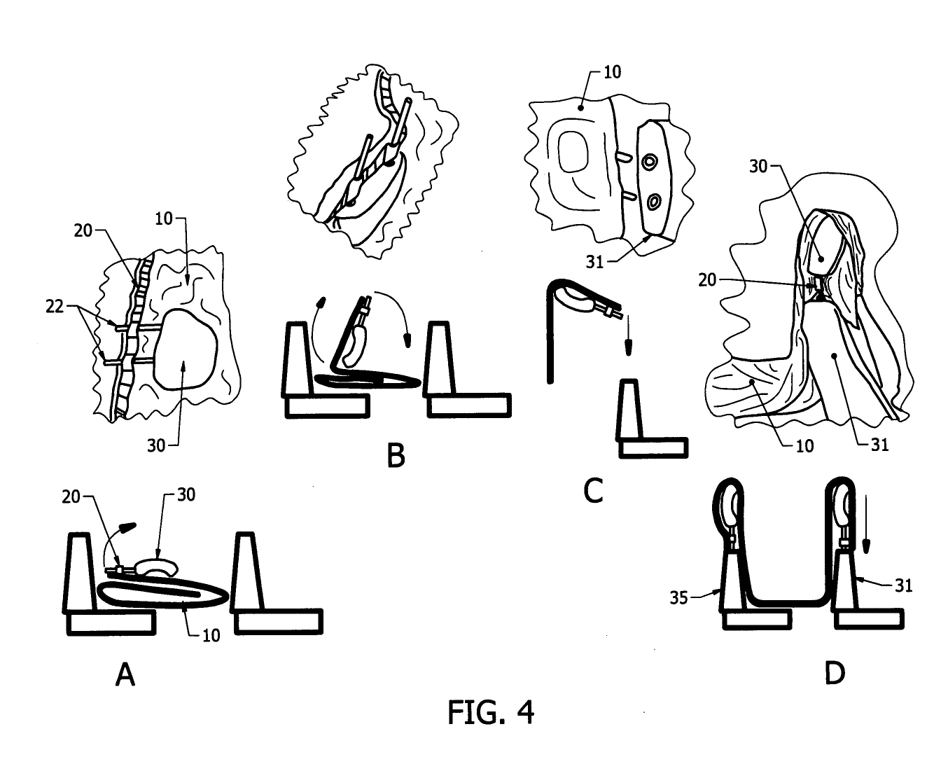

As illustrated in FIG. 1 in a preferred embodiment the apparatus for covering of the vehicle salon comprising of a base flexible sheet of material 10 with plurality of slots, loops or openings 22. This seat cover will work even with only one webbing or two on opposite sides. In a preferred embodiment said apparatus, or vehicle salon cover, has four narrow strips of webbing 20 attached in the middle portion of each side close to the edge of the sheet material 10. The strips 20 have multiple cross stitches 21 creating slots 22 between webbing and the sheet material of the cover for pins of the vehicle's seat headrests to go through.
As shown in FIG. 2 once the vehicle cover 10 is attached to the front and rear headrests, the sides of the cover can be raised to protect the doors of the vehicle from the inside, creating a four walls and a bottom cradle-like enclosure.
To keep the side panels of the cover in vertical position a strap 25, cord or other tie up can be attached to one of the slots in the side webbing 20 close to the rear seat and wrapped behind the back of the back set 35 and tied up to the rear headrests 33 of the vehicle (see FIG. 3) and the front portion of the side webbing can be attached to the front headrest or any other suitable support surface in a vehicle in a similar manner. The method of placing the vehicle salon cover is described in FIG. 4. it is obvious that Headrest pins can be simply inserted in the slots and then into the back of the seat. The method subject of this invention allows to cover the headrest as well and also form a higher barrier/wall along backs of two front seats that prevents a pet, such as dog, from jumping into the front of the vehicle.
Installing front end of the cover 10 will require rotating the headrests and wrapping the cover around them in a manner specified below.
Step by step process of installing the front end of the cover is shown in FIG. 4 from perspective view from the right side of the vehicle. It shows a diagram along with an overview of each step:
Step 1. Cover 10 must be placed on the back bench seat of the vehicle with top side up. Front side facing the front seats 31 and back side facing back of the back seat. Then the back portion of the cover should be folded forward so it lays on top of the middle portion with webbing facing upwards and the front portion of the cover should be folded backwards so the webbing 20 facing upwards.
Step 2. Front headrest 30 has to be removed from the seat and placed on the front portion of the cover “face” down, “face” being a side of the headrest facing forward when installed correctly. The pillow portion of the headrest should be placed on the cover with pins directed outward and going through the slots 22 formed by the stitches in the webbing 20 as shown in FIG. 4-A.
Step 3. If standing on the right hand side of the vehicle rotate the headrest clockwise wrapping the cover around the headrest (counterclockwise if standing at the left side of the vehicle) as shown in FIG. 4-B
Step 4. Keep rotating the headrest and bring it up to match the headrest receptacles in the back of the front seat as shown in FIG. 4-C.
Step 5. Insert the Headrest in the back of the seat 31 with the cover attached to it as shown in FIG. 4 D.
To install back seat headrest repeat the Steps 2-5 as described above except that the headrest should be placed “face” up on the cover, then pins inserted in appropriate slots and headrest rotated counterclockwise.
Use the same procedure to cover cargo area to attach the front end of the cover to the appropriate headrests. The sides can be also risen and tied up to various supporting surfaces in the vehicle with a simple string, strap or any suitable tie up (see FIG. 2).

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An apparatus for covering seat and/or salon/cargo area in vehicles comprising a flexible base sheet with plurality of slots and/or loops;

2. An apparatus for covering seat and/or salon/cargo area in vehicles as described in claim one further comprising a flexible base sheet with at least one narrow strip of material such as webbing, stitched to the said sheet in a way to form plurality of slots and/or loops;

3. An apparatus for covering seat and/or salon/cargo area in vehicles as described in claim one further comprising a flexible base sheet with openings created by installing grommets or similar device to match the location and diameter and for use with headrest pins;

4. A method of using the apparatus for covering seat and/or salon/cargo area in vehicles comprising of steps of inserting headrest's pins into the slots formed by the said strip of material stitched to the sheet, or grommets, and then partially wrapping the sheet around the headrest and inserting the headrest into the corresponding headrest slots in the back of the car front and/or rear seats;

5. The method of using the apparatus for covering seat and/or salon/cargo area in vehicles as described in claim 4, further comprising of steps of raising the sides of the said cover by connecting/tying up a string, or strap, or cord, or any such connection to appropriate slots formed by strip of material stitched on the sides of the said sheet to appropriate slots on front or back of the said sheet or other suitable attachments on the vehicle, such as headrest pins, handles, cargo loops/hooks and such, to support sides of said cover in vertical position.
